(19) United States
(12) Patent Application Publication
(10) Pub. No.: US 2016/0216498 A1
(43) Pub. Date: Jul. 28, 2016

(54) MICROSCOPE WITH AN ELEMENT FOR CHANGING THE SHAPE OF THE ILLUMINATING LIGHT FOCUS POINT

(71) Applicant: LEICA MICROSYSTEMS CMS GMBH, Wetzlar (DE)

(72) Inventors: Volker SEYFRIED, Nussloch (DE); Vishnu Vardhan KRISHNAMACHARI, Seeheim-Jugenheim (DE); Arnold GISKE, Sandhausen (DE)

(21) Appl. No.: 14/916,486

(22) PCT Filed: Sep. 3, 2014
(86) PCT No.: PCT/EP2014/068747

§ 371 Date: Mar. 3, 2016

(30) Foreign Application Priority Data
Sep. 3, 2013 (DE) 10 2013 217 498.5
Dec. 23, 2013 (DE) 10 2013 227 107.7

(51) Int. Cl. G02B 21/00; G02F 1/29; G02F 1/33; G02B 6/26; G02B 27/09

(52) U.S. Cl. CPC G02B 21/0032; G02B 6/262; G02B 21/0076; G02B 21/0068; G02B 27/09; G02F 1/33; G02F 1/292; G02B 27/0905

(57) ABSTRACT

The invention relates to a microscope having an objective that focuses illuminating light to an illuminating light focus, and having a light-guiding fiber which transports the illuminating light and at whose end is arranged a fiber coupler that couples the illuminating light out of the light-guiding fiber and generates a preferably collimated illuminating light bundle. An element for modifying the shape of the illuminating light focus, which is prealigned relative to the illuminating light bundle to be coupled out, is arranged in or on the fiber coupler.

The invention relates to a microscope having an objective that focuses illuminating light to an illuminating light focus, and having a light-guiding fiber which transports the illuminating light and at whose end is arranged a fiber coupler that couples the illuminating light out of the light-guiding fiber and generates a preferably collimated illuminating light bundle.

In confocal scanning microscopy, for example, a specimen to be investigated is scanned in three dimensions with the focus of at least one illuminating light bundle, which is often transported with the aid of a light-guiding fiber from a light source to the site of incoupling into the microscopic beam path. A confocal scanning microscope generally encompasses a light source, a focusing optical system with which the light of the source is focused onto an aperture (called the “excitation pinhole”), a beam splitter, a beam deflection device for beam control, a microscope optical system, a detection pinhole, and detectors for detecting the detected light or fluorescent light. The illuminating light is coupled in, for example, via the beam splitter.

The focus of such an illuminating light bundle can be moved in a specimen plane, for example, with the aid of a controllable beam deflection device, generally by tilting two mirrors; the deflection axes are usually perpendicular to one another, so that one mirror deflects in an X direction and the other in a Y direction. Tilting of the mirrors is brought about, for example, with the aid of galvanometer positioning elements. The power level of the light coming from the specimen is measured as a function of the position of the scanning beam.

The fluorescent light coming from the specimen travels via the beam deflection device back to the beam splitter, passes through the latter, and is then focused onto the detection pinhole behind which the detectors are located. Detected light that does not derive directly from the focus region takes a different light path and does not pass through the detection pinhole, so that a spot information item is obtained which results, by sequential scanning of the specimen in multiple planes, in a three-dimensional image.

In a microscope, in particular in a scanning microscope or a confocal scanning microscope, samples are often illuminated with an illuminating light bundle that has been generated by combining multiple illuminating light bundles, in order to observe the reflected or fluorescent light emitted from the illuminated sample.

Dichroic beam splitters are usually used in the optical system in order to combine light bundles having different wavelengths. DE 196 33 185 A1, for example, discloses a point light source for a laser scanning microscope and a method for coupling the light of at least two lasers having different wavelengths into a laser scanning microscope. The point light source is of modular configuration and contains a dichroic beam combiner that combines the light of at least two laser light sources and couples it into a light-guiding fiber leading to the microscope.

The resolution capability of a confocal scanning microscope is determined, among other factors, by the intensity distribution and physical extent of the focus of the excitation light bundle in the sample. Because of the diffraction limit, the resolution capability cannot be arbitrarily increased by greater focusing. The focus of an illuminating light bundle emitted from a laser is usually rotationally symmetrical with respect to the optical axis and has a Gaussian beam shape, the light power level decreasing outward from the optical axis.

An arrangement for increasing the resolution capability for fluorescence applications is known from WO 95/21393 A1. This document discloses illuminating the lateral edge region of a focus volume (as described above) of the excitation light bundle with the foci of multiple deexcitation light bundles, which likewise have the shape described above, so that an induced emission is produced therein and the sample regions, excited by the excitation light bundle, are brought therein back into the ground state in stimulated fashion. Only the spontaneously emitted light from the regions not illuminated by the deexcitation light bundles is then detected, so that an overall improvement in resolution is achieved. The term “stimulated emission depletion” (STED) has become established for this method.

STED technology has in the meantime been further developed. In most cases, instead of inhomogeneous deexcitation light illumination with the (conventionally shaped) foci of multiple deexcitation light bundles, the deexcitation light is shaped into a internally hollow focus. An element for modifying the shape of the illuminating light focus of the deexcitation light bundle is arranged for this purpose in the beam path of the deexcitation light.

This element can comprise, for example, a phase filter or a progressive phase filter or a segmented phase filter or a switchable phase matrix, in particular an LCD matrix. Provision can be made in particular to generate in the sample, with the aid of the element for modifying the shape of the illuminating light focus, an annular focus (called a “donut focus”) that overlaps with the focus of the excitation light bundle in the X-Y plane, i.e. in a plane perpendicular to the optical axis, in order to bring about an increase in resolution in an X-Y direction. An annular focus can be achieved, for example, with a so-called vortex phase filter.

A STED microscope having special phase filters is known, for example, from Klar et al., “Breaking Abbe's diffraction resolution limit in fluorescence microscopy with stimulated emission depletion beams of various shapes,” Physical Rev. E, Statistical Physics, Plasmas, Fluids and Related Interdisciplinary Topics, American Institute of Physics, New York, N.Y., Vol. 64, No. 6, Nov. 26, 2001, 066613-1 to 066613-9.

The known microscopes have the disadvantage that they must be very accurately aligned in terms of the phase filters, which is very laborious. In addition, such microscopes are very susceptible to misalignment of the phase filters that are usually secured in separate holders, which immediately results in a loss of resolution capability.

The object of the present invention is therefore to describe a microscope in which these disadvantages are avoided.

The object is achieved by a microscope which is characterized in that an element for modifying the shape of the illuminating light focus, which is aligned relative to the illuminating light bundle to be coupled out, is arranged in or on the fiber coupler.

The invention has the advantage that laborious alignment of the element for modifying the shape of the illuminating light focus in the context of commissioning of a microscope is completely eliminated. Instead, because of the prealignment, all that is necessary is to position the fiber coupler in its target position and secure it. Alignment of the fiber coupler can be brought about quickly and simply, however, since the beam profile of the outcoupled illuminating light bundle can easily be tracked and the fiber coupler can easily be realigned in the event of a deviation from a target profile. Aligning the element for modifying the shape of the illuminating light focus relative to the illuminating light bundle to be coupled out would be substantially more laborious, since a misalignment would not be detectable with simple means, in particular not by merely tracking the beam profile. According to the present invention, however, this laborious alignment of the element for modifying the shape of the illuminating light focus relative to the illuminating light bundle to be coupled out is advantageously avoided.

In a particular embodiment the element for modifying the shape of the illuminating light focus is arranged and/or fastened on a housing of the fiber coupler and/or on a front lens of the fiber coupler. Alternatively, provision can also be made that the element for modifying the shape of the illuminating light focus is integrated into the fiber coupler and/or is arranged in a housing of the fiber coupler.

In a particularly advantageous embodiment at least one further light-guiding fiber is present which transports further illuminating light that is focused by the objective to a further illuminating light focus, and arranged at its end is a further fiber coupler that couples the further illuminating light out of the further light-guiding fiber and generates a further preferably collimated illuminating light bundle. Provision can be made here in particular that a further element for modifying the shape of the further illuminating light focus is arranged on the further fiber coupler.

Preferably the fiber coupler is connected to the light-guiding fiber via a bayonet-like insertion connection. Provision can also be made that the further fiber coupler is connected to the further light-guiding fiber via a bayonet-like insertion connection. Such an embodiment facilitates the replacement of components, for example in the event of repairs.

The element for modifying the shape of the illuminating light focus can comprise, for example, a phase filter or a progressive phase filter or a segmented phase filter or a switchable phase matrix, in particular an LCD matrix.

In addition to the illuminating light bundle or to the at least one further illuminating light bundle that has been transported through further light-guiding fibers, provision can advantageously be made that an additional illuminating light bundle, which does not pass through any light-guiding fiber and/or any element for modifying the shape of the illuminating light focus, is coupled into the illuminating light beam path so that the objective also focuses the additional illuminating light bundle.

In order to achieve, for example, an increase in resolution, provision can advantageously be made that at least one of the illuminating light bundles (illuminating light bundle and/or further illuminating light bundle and/or additional illuminating light bundle) is embodied and intended to bring about a fluorescent excitation in a sample, while at least one other of the illuminating light bundles is embodied and intended to bring about a stimulated emission in a sample.

An embodiment in which at least of the illuminating light bundles previously described, i.e. in particular

a. the illuminating light bundle and the further illuminating light bundle, or
b. the illuminating light bundle and the additional illuminating light bundle, or
c. the further illuminating light bundle and the additional illuminating light bundle, or
d. the illuminating light bundle and the further illuminating light bundle and the additional illuminating light bundle,
are coupled into a beam combiner which the incoupled illuminating light bundles leave in collinearly combined fashion, is very particularly advantageous. Provision can be made here in particular that at least a first and a second of the illuminating light bundles (illuminating light bundle and/or further illuminating light bundle and/or additional illuminating light bundle) have the same illuminating light wavelength but a different polarization, in particular linear polarization.

In a very particularly advantageous embodiment the beam combiner is embodied as an acousto-optic beam combiner and is constructed and operated in such a way that by interaction with at least one mechanical wave, both the first illuminating light bundle and the second illuminating light bundle are diffracted and are thereby directed into a common optical axis. Such an embodiment has the very particular advantage that depending on the application requirements, individual illuminating light portions can be interrupted or enabled again, or individually and separately adjusted in terms of the illuminating light power level, in targeted fashion.

Such an embodiment has the very particular advantage that the acousto-optic beam combiner can be switched very quickly, within a few microseconds. An illuminating light bundle can thereby, for example, be quickly interrupted or enabled again. The possibility of a rapid switchover to other wavelengths or other wavelength combinations is also a particular advantage of such an embodiment.

The manner of operation of an acousto-optic beam combiner of this kind is based substantially on the interaction of the incoupled illuminating light bundles with a mechanical wave or with multiple mechanical waves.

Acousto-optic components are generally made up of a so-called acousto-optic crystal, on which is mounted an electrical converter (often referred to in the literature as a “transducer”). The converter usually encompasses a piezoelectric material as well as one electrode located above it and one located below it. Electrical activation of the electrodes with radio frequencies, which are typically in the region between 30 MHz and 800 MHz, causes the piezoelectric material to vibrate, so that an acoustic wave (i.e. a sound wave) can occur and, once produced, passes through the crystal. After passing through an optical interaction region, the acoustic wave is usually absorbed or reflected away at the oppositely located side of the crystal.

Acousto-optic crystals are notable for the fact that the resulting sound wave modifies the optical properties of the crystal, a kind of optical grating or comparable optically active structure, for example a hologram, being induced by the sound. Light passing through the crystal experiences a diffraction at the optical grating. The light is correspondingly directed into various diffraction orders in diffraction directions. There are acousto-optic components that influence all of the incident light more or less irrespective of wavelength. Reference may be made, solely by way of example, to components such as AOMs, AODs, and frequency shifters. Components moreover also already exist that, for example, act selectively on individual wavelengths as a function of the irradiated radio frequency (AOTFs). The acousto-optic elements are often made of birefringent crystals, for example tellurium oxide; the optical effect of the respective element is determined in particular by the location of the crystal axis relative to the incidence direction of the light and its polarization.

Especially when, for example, an AOTF is used in the acousto-optic beam combiner, the mechanical wave must have a very specific frequency so that the Bragg condition is exactly satisfied for light having the desired illuminating light wavelength and the desired polarization. In these acousto-optic components, light for which the Bragg condition is not satisfied is not deflected by the mechanical wave.

In a particularly simple embodiment of a microscope according to the present invention having a beam combiner, in which the latter can contain, for example, a commercially usual AOTF, the acousto-optic beam combiner comprises a crystal through which a first and a second mechanical wave having different acoustic frequencies propagate simultaneously, the crystal and the propagation direction of the mechanical waves being oriented, relative to one another and respectively relative to the illuminating light bundles incident into the crystal, in such a way that the first illuminating light bundle is diffracted at the first mechanical wave and the second illuminating light bundle at the second mechanical wave, and they are thereby directed into a common optical axis.

It is particularly advantageous in this context if the combined illuminating light bundle leaves the crystal through an exit surface oriented perpendicularly to the propagation direction of the illuminating light bundle. Directional changes or a spatial division of the illuminating light bundle do not occur upon a change in wavelength or if the illuminating light bundle comprises multiple wavelengths.

This embodiment has the disadvantage, however, that two different mechanical waves must be generated in order to deflect two illuminating light bundles that have the same wavelength but a different polarization. The generator for the mechanical waves, for example a piezoelement arranged on the crystal, must thus be impinged upon simultaneously by two different electromagnetic HF waves. The result, disadvantageously, is that twice the amount of thermal power is introduced into the crystal or crystals, which ultimately reduces the diffraction efficiency and, because of the unavoidable temperature fluctuations, also causes the deflection directions and thus the light power levels of the light arriving at the sample and at the detector to fluctuate. “Beat” phenomena can also occur if the frequency ranges of the mechanical waves overlap, ultimately resulting in periodic fluctuations in the light power level of the light arriving at the sample and/or at the detector. This problem is based in particular on the fact that the mechanical waves by their nature cannot have an infinitesimally small, i.e. singular, acoustic frequency, but instead that a frequency range around a center frequency must always be present.

In a very particularly advantageous embodiment, a commercially usual AOTF is therefore not used. The acousto-optic beam combiner instead comprises a crystal through which a mechanical wave having an acoustic frequency associated with the wavelength of the first and of the second illuminating light bundle propagates, the crystal and the propagation direction of the mechanical wave being oriented, relative to one another and respectively relative to the illuminating light bundles incident into the crystal, in such a way that both the first illuminating light bundle and the second illuminating light bundle are diffracted at the mechanical wave and are thereby directed into a common optical axis.

Provision can be made here in particular that the first illuminating light bundle is linearly polarized and has a linear polarization direction that is the linear polarization direction of the ordinary light with respect to a birefringence property of the crystal; and/or that the second illuminating light bundle is linearly polarized and has a linear polarization direction that is the linear polarization direction of the extraordinary light with respect to a birefringence property of the crystal. Provision can also be made, in particular, that the linear polarization direction of the first illuminating light bundle or the linear polarization direction of the second illuminating light bundle is arranged in the plane that is spanned by the propagation direction of the mechanical wave and the propagation direction of the detected light bundle.

The specific configuration of an acousto-optic beam combiner of this kind, in particular the orientation of the crystal relative to the propagation direction of the mechanical wave(s) and to the propagation direction of the illuminating light bundles, and the orientation of the mechanical wave and the illuminating light bundles relative to one another, as well as the orientation of the entrance and exit surfaces with respect to one another and to the optical axis of the crystal, can be developed, for example, in accordance with the iterative method discussed below; preferably the method is pursued not on the basis of real components (although that would also be possible) but instead in a computer simulation, until the individual parameters of crystal shape, orientation of the surfaces and of the crystal lattice, orientation of the propagation direction of the mechanical wave(s), and propagation directions of the illuminating light bundles, conform to the desired requirements. When all the relevant parameters have been ascertained in this manner in a computer simulation, the crystal can then be manufactured in a further step.

It is possible to proceed in this context, for example, firstly from the embodiment that is described above and in which the acousto-optic beam combiner comprises a commercially usual crystal, through which a first and a second mechanical wave of different acoustic frequencies would actually need to propagate simultaneously in order to direct both the first illuminating light bundle and the second illuminating light bundle into a common optical axis.

The reverse light path is considered for the iteration method; and on the reverse light path the first and the second illuminating light bundle are collinearly coupled through the (preferably perpendicularly oriented) exit surface into the crystal, but only the first of the mechanical waves is generated in the crystal. The consequence of this is that only the first illuminating light bundle is diffracted at the mechanical wave, while the second light bundle, which has the same wavelength but the other linear polarization direction, passes undeflected through the crystal.

The crystal is then rotated, preferably in the plane that is spanned by the incident collinear illuminating light bundle and the propagation direction of the mechanical wave, and the angle between the propagation direction of the mechanical wave and the crystal axes is thus also modified, until both illuminating light bundles having both linear polarization portions are deflected by the mechanical wave.

The result of the rotation is generally, however, that the exit surface is no longer perpendicular to the incident collinear illuminating light bundle. For this reason, in a next iteration step the shape of the crystal is modified—without rotating the crystal—in such way that the exit surface is once again perpendicular to the incident collinear illuminating light bundle.

The result of the changes in the crystal shape is generally, however, that both linear polarization portions having the illuminating light wavelength can no longer each be deflected with the mechanical wave. For this reason, the crystal is then rotated again until this condition is again satisfied. The further iteration steps already described are then repeated.

A sufficient number of iteration cycles are carried out until the condition of simultaneous deflection of both linear polarization portions, and the condition of collinear light exit, are satisfied. As a rule the method converges very quickly, so that the goal is reached after a few iteration cycles.

In a particular embodiment, care is respectively taken upon rotation of the crystal that with respect to one of the linear polarization directions of the illuminating light proceeding in reverse, all of the light that is diffracted into the first order, and that has the illuminating light wavelengths, exits the crystal collinearly. Such an embodiment has the advantage not only that both portions having a different linear polarization can respectively be deflected with a single mechanical wave, but also that multi-colored collinearly incident illuminating light can additionally be diffracted collinearly into an illuminating light beam path via the light path of the first diffraction order, for which the above-described collinearity exists. Advantageously, no compensation for spatial divisions is required for this illuminating light, since they do not exist for this illuminating light.

With such an embodiment provision can be made, for example, that the crystal or the second crystal comprises an entrance surface for primary light having multiple wavelengths and an exit surface for the illuminating light bundle directed into the common optical axis, the entrance surface and exit surface being oriented with respect to one another in such a way that the primary light is incouplable into the crystal as a collinear illuminating light bundle, and the illuminating light bundle directed into the common optical axis leaves the crystal as a collinear illuminating light bundle.

In an advantageous embodiment provision is made that at least one further illuminating light bundle, which does not have the wavelength of the first and second illuminating light bundle and is not diffracted at the mechanical wave, proceeds through the crystal and travels, together with the first and the second illuminating light bundle, into the common optical axis. Such an embodiment makes it possible in particular to arrange multiple acousto-optic components successively, as described below in detail.

Provision can be made, for example, for the further illuminating light bundle to emerge from a second crystal in which a second mechanical wave, which has an acoustic frequency associated with the wavelength of the further illuminating light bundle, propagates, the further illuminating light bundle containing a third illuminating light bundle having the further illuminating light wavelength, which is diffracted by the second mechanical wave; or that the further illuminating light bundle contains a third and a fourth illuminating light bundle having the further illuminating light wavelength but a different polarization, in particular linear polarization, which have been diffracted by the second mechanical wave. In order to implement the latter variant the second crystal should preferably be constructed so that, as discussed in detail above, it deflects the illuminating light having the further wavelength irrespective of its polarization.

As already discussed, provision can advantageously be made that the previously mentioned principles are simultaneously applied in multiple fashion, by the fact that multiple mechanical waves of different frequencies, for illuminating light having different wavelengths, are generated in at least one crystal.

Provision can be made, for example, that at least one additional mechanical wave, which has another acoustic frequency associated with an additional wavelength, simultaneously propagates in the crystal or in the second crystal, at least one additional illuminating light bundle, which has the other wavelength, being diffracted at the additional mechanical wave and thereby being directed into the common optical axis; and/or two additional illuminating light bundles, which have the other wavelength and a polarization, in particular a linear polarization, different from one another, being diffracted at the additional mechanical wave and being thereby directed into the common optical axis.

In a particular embodiment the acousto-optic beam combiner comprises at least one dispersive optical component that compensates for a spatial spectral division produced (at least in part) by the crystal or the second crystal. This can refer, for example, to a division of an illuminating light bundle that contains light having multiple wavelengths. Provision can also be made, however, that the dispersive optical component also, in addition to a compensation for a division of illuminating light, compensates for a spatial spectral division of detected light.

The dispersive optical component can be disposed so that it undoes a spatial spectral division that has already occurred. The compensation can also be accomplished, however, in such a way that the dispersive optical component causes a spatial spectral division that is undone by the crystal or by the second crystal.

Very particularly advantageously, the acousto-optic beam combiner can receive the light of multiple primary light sources whose illuminating light bundles are combined, optionally after a wavelength selection, by the acousto-optic beam combiner.

It is also possible for at least one of the primary light sources to generate unpolarized primary light, in particular white light. A light source of this kind can comprise, for example, a polarizing beam splitter that receives the unpolarized primary light and divides it spatially, as a function of the linear polarization direction, so that the resulting illuminating light beam bundles can be exposed, via different inputs of a crystal or of multiple crystals, to the action of the mechanical wave or to the action of the mechanical waves. Illuminating light having one or more wavelengths can thereby be selected and collinearly directed, in a very targeted and extremely flexibly switchable fashion, into an illumination beam path in order to illuminate a sample, with no loss, for example, of the light intensity of the unpolarized primary light (aside from the usual losses upon incoupling and outcoupling into and from optical components). In particular, it is not necessary in principle to dispense entirely with light of one linear polarization direction.

Provision can advantageously be made that the beam combiner functions as a main beam splitter that directs illuminating light into an illuminating light beam path in order to illuminate a sample, and that directs the detected light emerging from the sample into a detection beam path having a detector.

In a particular embodiment, both a portion of the detected light bundle having the illuminating light wavelength and a first linear polarization direction, and a portion of the detected light having the illuminating light wavelength and a second linear polarization direction perpendicular to the first linear polarization direction, are deflected out of a detected light bundle coming from a sample by interaction with the mechanical wave of the crystal, and are thereby removed from the detected light bundle. Alternatively or additionally, provision can also be made that both a portion of the detected light bundle having the further illuminating light wavelength and a first linear polarization direction, and a portion of the detected light having the further illuminating light wavelength and a second linear polarization direction perpendicular to the first linear polarization direction, are deflected out of a detected light bundle coming from a sample by interaction with the mechanical wave of the second crystal, and are thereby removed from the detected light bundle.

Alternatively or additionally, it is also possible for the crystal and the propagation direction of the mechanical wave to be oriented, relative to one another and respectively relative to the detected light bundle incident into the crystal, in such a way that the acousto-optic beam combiner deflects, with the mechanical wave, both the portion of the detected light bundle having the illuminating light wavelength and a first linear polarization direction, and the portion of the detected light bundle having the illuminating light wavelength and a second linear polarization direction perpendicular to the first polarization direction, and thereby removes them from the detected light bundle; and/or for the second crystal and the propagation direction of the second mechanical wave to be oriented, relative to one another and respectively relative to the detected light bundle incident into the second crystal, in such a way that the acousto-optic beam combiner deflects, with the second mechanical wave, both the portion of the detected light bundle having the further illuminating light wavelength and a first linear polarization direction, and the portion of the detected light bundle having the further illuminating light wavelength and a second linear polarization direction perpendicular to the first polarization direction, and thereby removes them from the detected light bundle.

As already mentioned analogously with reference to a successive arrangement of the crystals, provision can advantageously be made that the detected light bundle passes firstly through the crystal and then through the second crystal.

Irrespective of the specific embodiment of the acousto-optic beam combiner, but in particular in the context of an acousto-optic beam combiner in which a mechanical wave acts on the light portions having one illuminating light wavelength and both linear polarization directions, provision can advantageously be made that the beam-guiding components of the beam combiner are arranged and embodied in such a way that the remaining part of the detected light bundle leaves the acousto-optic beam combiner collinearly. The detected light bundle can in that fashion be conveyed in simple fashion to a detector, for example to a multi-band detector.

The microscope according to the present invention can advantageously be embodied as a scanning microscope or confocal scanning microscope, or as an ultrahigh-resolution scanning microscope or as a STED microscope.

Use of the microscope according to the present invention for investigation of a sample in stimulated emission depletion (STED) microscopy or in coherent anti-Stokes Raman spectroscopy (CARS) microscopy or in stimulated Raman scattering (SRS) microscopy or in coherent Stokes Raman scattering (CSRS) microscopy or in Raman-induced Kerr effect scattering (RIKES) microscopy is particularly advantageous.

The subject matter of the invention is schematically depicted in the drawings and will be described below with reference to the Figures, identically functioning elements being labeled with the same reference characters. In the drawings:

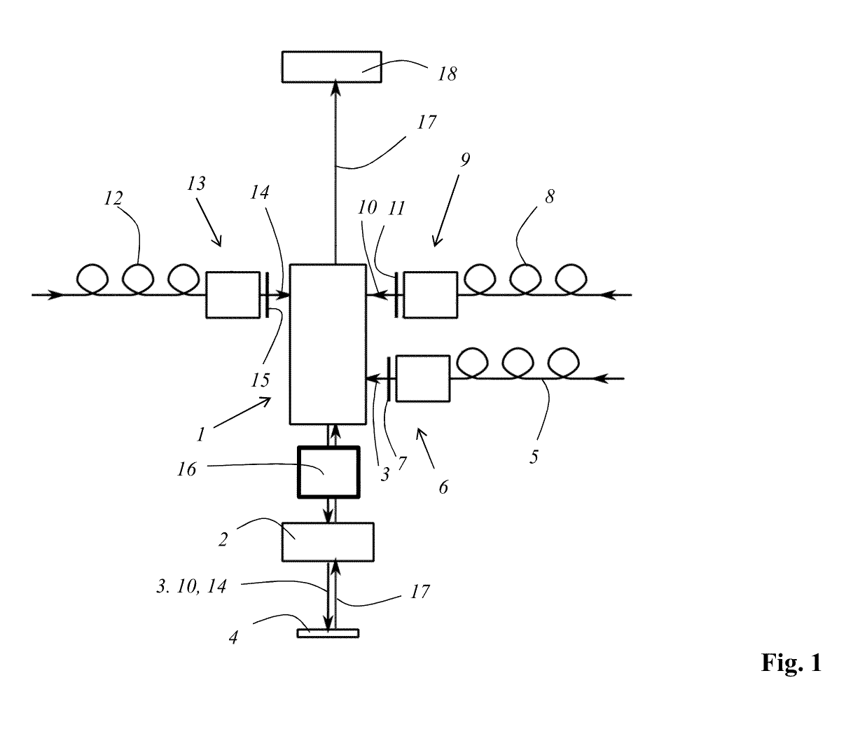

FIG. 1 schematically shows an exemplifying embodiment of a microscope according to the present invention having an acousto-optic beam combiner that functions as a main beam splitter; and

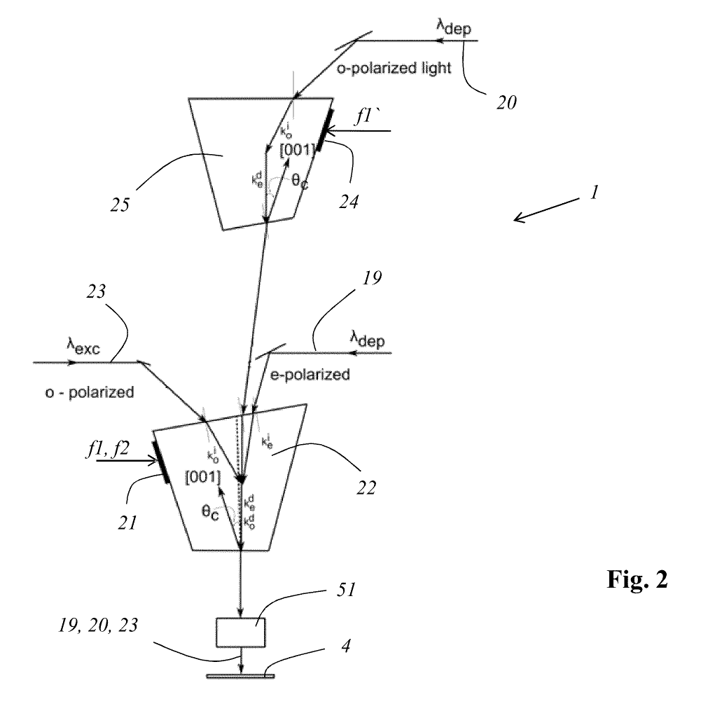

FIG. 2 shows an exemplifying embodiment of an acousto-optic beam combiner in a microscope according to the present invention.

FIG. 1 schematically shows an exemplifying embodiment of a microscope according to the present invention having an acousto-optic beam combiner 1 that functions as a main beam splitter. The microscope comprises an objective 2 that focuses illuminating light to an illuminating light focus in a sample 4, and has a light-guiding fiber 5, which transports illuminating light coming from a light source (not depicted) and at whose end is arranged a fiber coupler 6 that couples the illuminating light out of the light-guiding fiber and generates a preferably collimated illuminating light bundle 3. Arranged on fiber coupler 6 is an element 7 for modifying the shape of the illuminating light focus, for example a progressive phase filter, which is prealigned relative to illuminating light bundle 3 that is to be coupled out.

A further light-guiding fiber 8 is present, which transports further illuminating light that is focused by objective 2 to a further illuminating light focus and at whose end is arranged a further fiber coupler 9 that couples the further illuminating light out of further light-guiding fiber 8 and generates a further illuminating light bundle 10. A further element 11 for modifying the shape of the further illuminating light focus is arranged on further fiber coupler 9.

Also present is a third light-guiding fiber 12, which transports third illuminating light that is focused by objective 2 to a further illuminating light focus and at whose end is arranged a further fiber coupler 13 that couples the third illuminating light out of further light-guiding fiber 8 and generates a third illuminating light bundle 14. A third element 15 for modifying the shape of the further illuminating light focus is arranged on further fiber coupler 9.

Illuminating light bundle 3 coupled out of light-guiding fiber 5, further illuminating light bundle 10 coupled out of further light-guiding fiber 8, and third illuminating light bundle 14 coupled out of third light-guiding fiber 12 are coupled into an acousto-optic beam combiner 1 that the incoupled illuminating light bundles 3, 10, 14 leave in collinearly combined fashion. Provision can be made here in particular that at least two of illuminating light bundles 3, 10, 14 have the same illuminating light wavelength but a different polarization, in particular linear polarization.

In acousto-optic beam combiner 1, by interaction with mechanical waves the illuminating light bundles 3, 10, 14 both are diffracted and are thereby directed into a common optical axis. Such an embodiment has the very particular advantage that individual illuminating light portions can, in targeted fashion and depending on an application requirement, be interrupted or enabled again, or individually and separately adjusted in terms of illuminating light power level. The possibility of rapid switchover to other wavelengths or other wavelength combinations also exists.

The collinearly combined illuminating light bundles 3, 10, 14 travel via a beam deflection device 16 and objective 2 to sample 4 that is to be illuminated.

Detected light 17 emerging from sample 4 travels on the reverse light path back to acousto-optic beam combiner 1. Acousto-optic beam combiner 1 functions as a main beam splitter that (as already described) directs illuminating light into an illuminating light beam path in order to illuminate a sample 4, and allows detected light 17 emerging from sample 4 to pass to a detection beam path having a detector 18. It removes from detected light 17, by interaction with the mechanical waves, those portions which comprise the illuminating light wavelengths of illuminating light bundles 3, 10, 14.

FIG. 2 shows an exemplifying embodiment of an acousto-optic beam combiner 1 in a microscope according to the present invention with reference to a specific utilization capability in STED microscopy; only the path of the illuminating light that impinges upon sample 4 is depicted, but not (for better clarity) the path of the detected light.

In the exemplifying embodiment depicted in FIG. 2, acousto-optic beam splitter 15 is used to direct both deexcitation light bundles 19, 20 each having the wavelength λ_{dep} and a different linear polarization, coming from different light-guiding fibers (not depicted here) with the aid of fiber couplers that each comprise an element for modifying the shape of the illuminating light focus, and an excitation light bundle 23 having wavelength λ_{exc}, into an illumination beam path for illumination of a sample 4.

Piezo acoustic generator 21 of a first crystal 22 is impinged upon by a high-frequency wave having frequency f1 and by a high-frequency wave having frequency f2, and generates two mechanical waves (not depicted) propagating through first crystal 22, each having an acoustic frequency corresponding to one of frequencies f1 and f2.

Excitation light bundle 23 having wavelength λ_{exc} is coupled in via first crystal 22. By interaction with the mechanical wave that is generated by impingement of the high-frequency wave, having frequency f2, on piezo acoustic generator 21 of first crystal 22, excitation light bundle 23 is diffracted and is directed into an illumination beam path for illumination of a sample 4. Incoupling via first crystal 22 is particularly advantageous because the excitation light reflected at sample 4 can be filtered out of the detected light both in first crystal 22 with the mechanical wave having frequency f2 propagating therein, and with a mechanical wave propagating in second crystal 25.

First deexcitation light bundle 19, having an extraordinary linear polarization direction, is likewise coupled in via first crystal 22 and, by interaction with the mechanical wave generated by impingement of the high-frequency wave having frequency f1 on piezo acoustic generator 21, is diffracted and directed into the illumination beam path for illumination of sample 4. First deexcitation light bundle 19 and excitation light bundle 23 leave crystal 22 in collinearly combined fashion.

A piezo acoustic generator 24 of second crystal 25 is impinged upon by a high-frequency wave having frequency f1′ and generates a mechanical wave (not depicted) of an acoustic frequency corresponding to frequency f1′, propagating through second crystal 25. By interaction with this mechanical wave, second deexcitation light bundle 20 having wavelength λ_{dep}, which has an ordinary linear polarization direction with respect to the birefringence property of second crystal 25, is diffracted and then proceeds, undeflected by the mechanical waves of first crystal 22 propagating there, through first crystal 22 into illumination beam path and lastly arrives at sample 4. Second deexcitation light bundle 20 experiences no deflection as a result of the mechanical waves propagating in first crystal 22, since the Bragg condition is not satisfied for this light. Second deexcitation light bundle 20, first deexcitation light bundle 19, and excitation light bundle 23 leave crystal 22 in collinearly combined fashion and, after passing through a beam deflection device 16 (not depicted in FIG. 2) and objective 2 (not depicted in FIG. 2), encounter sample 4 that is to be illuminated.

As already mentioned, an element (not depicted) for modifying the shape of the illuminating light focus of deexcitation light bundle 19 is provided in the beam path of first deexcitation light bundle 19. This element can comprise, for example, a phase filter or a progressive phase filter or a segmented phase filter or a switchable phase matrix, in particular an LCD matrix. Provision can be made in particular that what is generated with the aid of the element for modifying the shape of the illuminating light focus is an annular focus (“donut focus”) in sample 4, which overlaps with the focus of excitation light bundle 19 in the X-Y plane, i.e. in a plane perpendicular to the optical axis, in order to bring about an increase in resolution in an X-Y direction. An annular focus can be achieved, for example, with a so-called vortex phase filter.

Also arranged in the beam path of second deexcitation light bundle 20 is a further element (not depicted) for modifying the shape of the illuminating light focus of deexcitation light bundle 20. Provision can be made in particular that with the aid of the further element for modifying the shape of the illuminating light focus, a double focus is generated which overlaps with the focus of excitation light bundle 23 in a Z direction, preferably above and below the center of the focus of deexcitation light bundle 23, in order to bring about increased resolution in a Z direction.

The invention has been described with reference to a particular embodiment, the same reference characters usually being used for identical or identically functioning components. It is self-evident, however, that modifications and variations can be carried out without thereby departing from the range of protection of the claims hereinafter.

1. A microscope having an objective that focuses illuminating light to an illuminating light focus, and having a light-guiding fiber which transports the illuminating light and at whose end is arranged a fiber coupler that couples the illuminating light out of the light-guiding fiber and generates a preferably collimated illuminating light bundle,
wherein an element for modifying the shape of the illuminating light focus, which is aligned relative to the illuminating light bundle to be coupled out, is arranged in or on the fiber coupler.

2. The microscope according to claim 1, wherein the element for modifying the shape of the illuminating light focus is arranged or fastened on a housing of at least one of the fiber coupler and on a front lens of the fiber coupler.

3. The microscope according to claim 1, wherein the element for modifying the shape of the illuminating light focus is integrated into the fiber coupler or is arranged in a housing of the fiber coupler.

4. The microscope according to claim 1, wherein at least one further light-guiding fiber is present which transports further illuminating light that is focused by the objective to a further illuminating light focus, and arranged at its end is a further fiber coupler that couples the further illuminating light out of the further light-guiding fiber and generates a further preferably collimated illuminating light bundle.

5. The microscope according to claim 4, wherein a further element for modifying the shape of the further illuminating light focus is arranged in or on the further fiber coupler.

6. The microscope according to claim 1, wherein the fiber coupler is connected to the light-guiding fiber via a bayonet-like insertion connection; or the further fiber coupler is connected to the further light-guiding fiber via a bayonet-like insertion connection.

7. The microscope according to claim 1, wherein the element for modifying the shape of the illuminating light focus comprises a phase filter or a progressive phase filter or a segmented phase filter or a switchable phase matrix or an LCD matrix.

8. The microscope according to claim 1, wherein the objective focuses an additional illuminating light bundle, which does not pass through any light-guiding fiber or any element for modifying the shape of the illuminating light focus.

9. The microscope according to claim 1, wherein at least one of the illuminating light bundles is embodied and intended to bring about a fluorescent excitation in a sample, while at least one other of the illuminating light bundles is embodied and intended to bring about a stimulated emission in a sample.

10. The microscope according to claim 4, wherein
a. the illuminating light bundle and the further illuminating light bundle, or
b. the illuminating light bundle and the additional illuminating light bundle, or
c. the further illuminating light bundle and the additional illuminating light bundle, or
d. the illuminating light bundle and the further illuminating light bundle and the additional illuminating light bundle
are coupled into a beam combiner which the incoupled illuminating light bundles leave in collinearly combined fashion.

11. The microscope according to claim 1, wherein at least a first and a second of the illuminating light bundles have the same illuminating light wavelength but a different polarization or a different linear polarization.

12. The microscope according to claim 11, wherein the beam combiner is embodied as an acousto-optic beam combiner and is constructed and operated in such a way that by interaction with at least one mechanical wave, both the first illuminating light bundle and the second illuminating light bundle are diffracted and are thereby directed into a common optical axis.

13. The microscope according to claim 12, wherein the acousto-optic beam combiner comprises a crystal through which a mechanical wave having an acoustic frequency associated with the wavelength of the first and of the second illuminating light bundle propagates, the crystal and the propagation direction of the mechanical wave being oriented, relative to one another and respectively relative to the illuminating light bundles incident into the crystal, in such a way that both the first illuminating light bundle and the second illuminating light bundle are diffracted at the mechanical wave and are thereby directed into a common optical axis.

14. The microscope according to claim 13, wherein
a. the first illuminating light bundle is linearly polarized and has a linear polarization direction that is the linear polarization direction of the ordinary light with respect to a birefringence property of the crystal; or
b. the second illuminating light bundle is linearly polarized and has a linear polarization direction that is the linear polarization direction of the extraordinary light with respect to a birefringence property of the crystal; or
c. the linear polarization direction of the first illuminating light bundle or the linear polarization direction of the second illuminating light bundle is arranged in the plane that is spanned by the propagation direction of the mechanical wave and the propagation direction of the detected light bundle.

15. The microscope according to claim 12, wherein the acousto-optic beam combiner comprises a crystal through which a first and a second mechanical wave having different acoustic frequencies propagate simultaneously, the crystal and the propagation direction of the mechanical waves being oriented, relative to one another and respectively relative to the illuminating light bundles incident into the crystal, in such a way that the first illuminating light bundle is diffracted at the first mechanical wave and the second illuminating light bundle at the second mechanical wave, and they are thereby directed into a common optical axis.

16. The microscope according to claim 12, wherein at least one further illuminating light bundle, which does not have the wavelength of the first and second illuminating light bundle and is not diffracted at the mechanical wave, proceeds through the crystal and travels, together with the first and the second illuminating light bundle, into the common optical axis.

17. The microscope according to claim 16, wherein the further illuminating light bundle emerges from a second crystal in which a second mechanical wave, which has an acoustic frequency associated with the wavelength of the further illuminating light bundle, propagates,
a. the further illuminating light bundle containing a third illuminating light bundle having the further illuminating light wavelength, which is diffracted by the second mechanical wave; or
b. the further illuminating light bundle contains a third and a fourth illuminating light bundle having the further illuminating light wavelength but a different polarization, which have been diffracted by the second mechanical wave.

18. The microscope according to claim 12, wherein at least one additional mechanical wave, which has another acoustic frequency associated with an additional wavelength, simultaneously propagates in the crystal or in the second crystal,
a. at least one additional illuminating light bundle, which has the other wavelength, being diffracted at the additional mechanical wave and thereby being directed into the common optical axis; or
b. two additional illuminating light bundles, which have the other wavelength and a polarization, different from one another, being diffracted at the additional mechanical wave and being thereby directed into the common optical axis.

19. The microscope according to claim 10, wherein the beam combiner functions as a main beam splitter that directs illuminating light into an illuminating light beam path in order to illuminate a sample, and that directs the detected light emerging from the sample into a detection beam path having a detector.

20. The microscope according to claim 10, wherein the beam combiner receives detected light emerging from a sample and removes from that detected light the portions that have at least one of the illuminating light wavelength and the further illuminating light wavelength and the other illuminating light wavelength.

21. The microscope according to claim 20, wherein
a. both a portion of the detected light bundle having the illuminating light wavelength and a first linear polarization direction, and a portion of the detected light having the illuminating light wavelength and a second linear polarization direction perpendicular to the first linear polarization direction, are deflected out of a detected light bundle coming from a sample by interaction with the mechanical wave of the crystal, and are thereby removed from the detected light bundle; or
b. both a portion of the detected light bundle having the further illuminating light wavelength and a first linear polarization direction, and a portion of the detected light having the further illuminating light wavelength and a second linear polarization direction perpendicular to the first linear polarization direction, are deflected out of a detected light bundle coming from a sample by interaction with the mechanical wave of the second crystal, and are thereby removed from the detected light bundle; or
c. the crystal and the propagation direction of the mechanical wave are oriented, relative to one another and respectively relative to the detected light bundle incident into the crystal, in such a way that the acousto-optic beam combiner deflects, with the mechanical wave, both the portion of the detected light bundle having the illuminating light wavelength and a first linear polarization direction, and the portion of the detected light bundle having the illuminating light wavelength and a second linear polarization direction perpendicular to the first polarization direction, and thereby removes them from the detected light bundle; or
d. the second crystal and the propagation direction of the second mechanical wave are oriented, relative to one another and respectively relative to the detected light bundle incident into the second crystal, in such a way that the acousto-optic beam combiner deflects, with the second mechanical wave, both the portion of the detected light bundle having the further illuminating light wavelength and a first linear polarization direction, and the portion of the detected light bundle having the further illuminating light wavelength and a second linear polarization direction perpendicular to the first polarization direction, and thereby removes them from the detected light bundle.

22. The microscope according to claim 20, wherein the detected light bundle passes firstly through the crystal and then through the second crystal.

23. The microscope according to claim 20, wherein the beam-guiding components of the beam combiner are arranged and embodied in such a way that the remaining part of the detected light bundle leaves the acousto-optic beam combiner collinearly.

24. The microscope according to claim 1, wherein the microscope is embodied as a scanning microscope or confocal scanning microscope, or as an ultrahigh-resolution scanning microscope or as a STED microscope.

25. Use of a microscope according to claim 1 for investigation of a sample in stimulated emission depletion (STED) microscopy or in coherent anti-Stokes Raman spectroscopy (CARS) microscopy or in stimulated Raman scattering (SRS) microscopy or in coherent Stokes Raman scattering (CSRS) microscopy or in Raman-induced Kerr effect scattering (RIKES) microscopy.

26. A fiber coupler having an element for modifying the shape of the illuminating light focus, which is prealigned relative to an illuminating light bundle to be coupled out, for manufacturing a microscope according to claim 1.
